(19) United States
(12) Patent Application Publication
(10) Pub. No.: US 2025/0260284 A1
(43) Pub. Date: Aug. 14, 2025

(54) WOUND FIELD MOTOR

(71) Applicant: Toyota Jidosha Kabushiki Kaisha, Toyota-shi (JP)

(72) Inventors: Daiki YAMADA, Toyota-shi (JP); Kenta Tabuchi, Nisshin-shi (JP)

(73) Assignee: Toyota Jidosha Kabushiki Kaisha, Toyota-shi (JP)

(21) Appl. No.: 18/946,065

(22) Filed: Nov. 13, 2024

(30) Foreign Application Priority Data
Feb. 9, 2024 (JP) 2024-018876

(51) Int. Cl. H02K 1/32; H02K 1/24; H02K 9/19

(52) U.S. Cl. CPC H02K 1/32; H02K 1/24; H02K 9/19

(57) ABSTRACT

The wound field motor includes a shaft having a hollow portion, a rotor core fixed to the shaft, and a rotor coil wound around the rotor core, wherein the rotor core includes a cylindrical back yoke, a plurality of teeth extending radially outward from an outer peripheral surface of the back yoke and wound with the rotor coil, and cooling holes provided in each of the plurality of teeth and extending along the axial direction.

### CROSS-REFERENCE TO RELATED APPLICATION

This application claims priority to Japanese Patent Application No. 2024-018876 filed on Feb. 9, 2024, incorporated herein by reference in its entirety.

### BACKGROUND

### 1. Technical Field

The present disclosure relates to wound field motors.

### 2. Description of Related Art

Japanese Unexamined Patent Application Publication No. 2020-39230 (JP 2020-39230 A) describes a technology in which a cooling hole is provided in the vicinity of a shaft of a rotor core of a wound field motor. In this technology, a refrigerant path is formed in a back yoke portion of the rotor core, and the refrigerant path is cooled by passage of refrigerant for axial oil cooling of the shaft.

### SUMMARY

However, JP 2020-39230 A has room for improvement in terms of cooling performance inside a rewound coil.

The present disclosure has been made in view of the above, and an object thereof is to provide a wound field motor in which cooling performance can be improved.

In order to solve the above problem and achieve the above object, a wound field motor according to the present disclosure includes:
a shaft having a hollow portion;
a rotor core fixed to the shaft; and
a rotor coil wound around the rotor core.
   The rotor core includes:
a cylindrical back yoke;
a plurality of teeth that extends radially outward from an outer peripheral surface of the back yoke and around which the rotor coil is wound; and
cooling holes provided in the teeth and extending along an axial direction.

The present disclosure provides an effect that the cooling performance can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall plan view including a wound field motor according to an embodiment;

FIG. 2 is a cross-sectional view of A-A of FIG. 1;

FIG. 3 is a schematic configuration diagram of a rotor included in the wound field motor according to the embodiment;

FIG. 4 is an enlarged partial view of the area D1 of FIG. 3;

FIG. 5 is an entire plan view illustrating a flow path of the coolant in the wound field motor 1; and

FIG. 6 is a cross-sectional view taken along B-B line of FIG. 5.

### DETAILED DESCRIPTION OF EMBODIMENTS

Hereinafter, a wound field motor according to an embodiment of the present disclosure will be described with reference to the drawings. The constituent elements in the following embodiments include those that can be easily replaced by a person skilled in the art or those that are substantially the same. In addition, the drawings referred to in the following description only schematically show shapes, sizes, and positional relationships to the extent that the contents of the present disclosure can be understood. That is, the present disclosure is not limited to only the shapes, sizes, and positional relationships illustrated in the drawings.

### Configuration of the Wound Field Motor

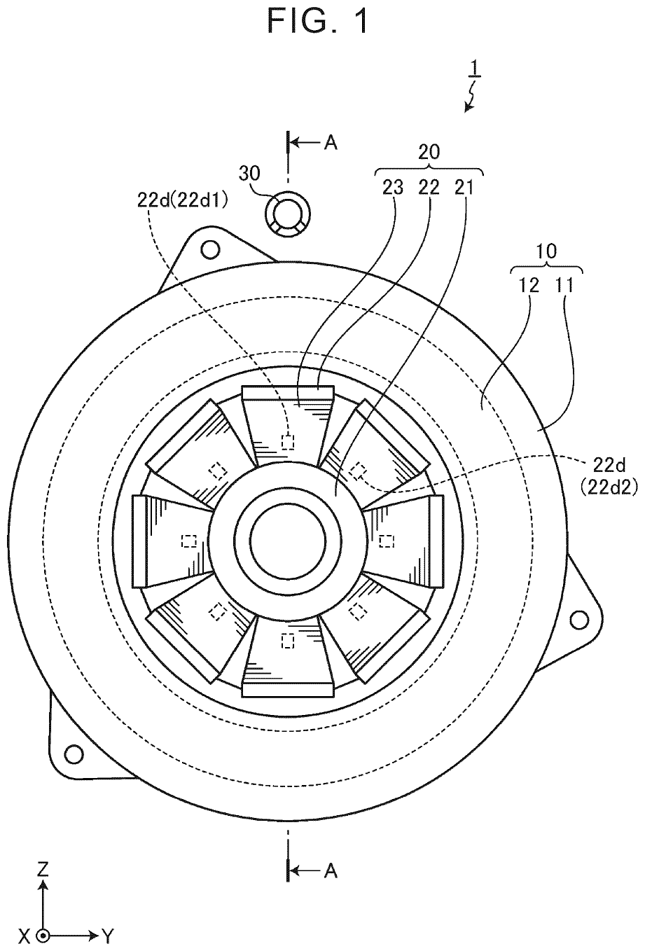

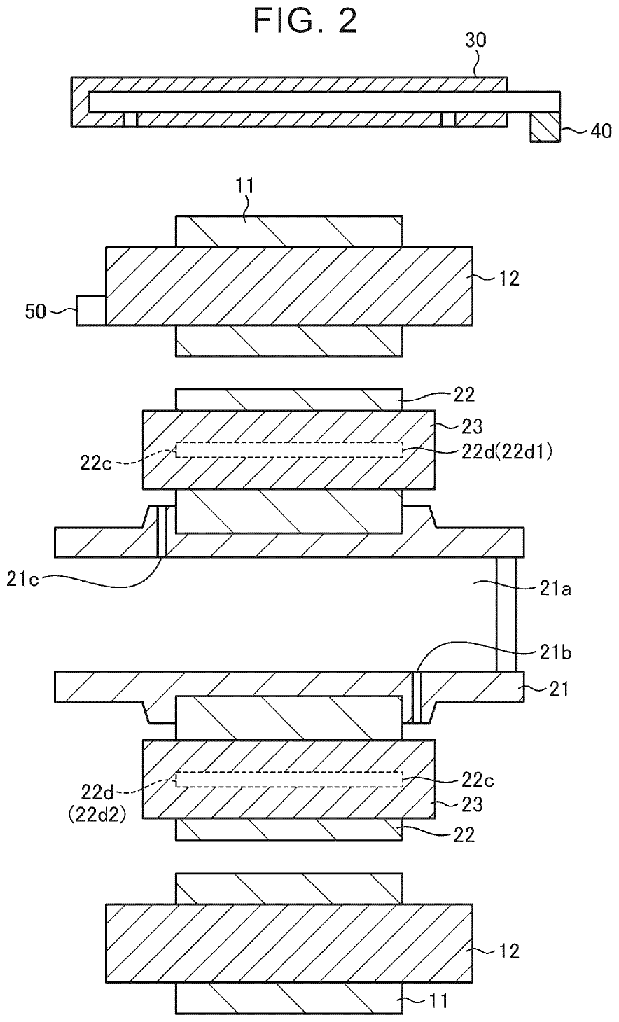

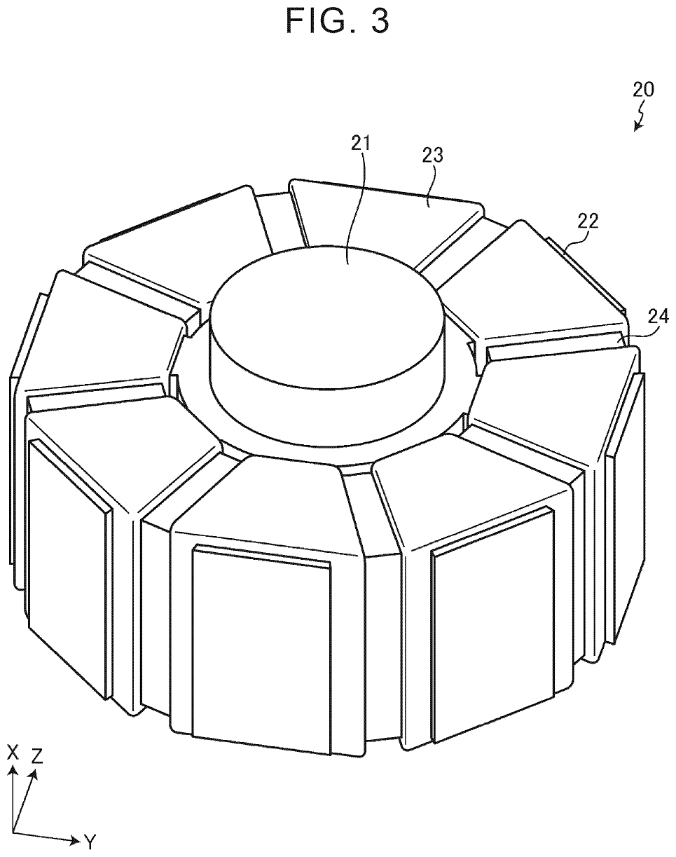

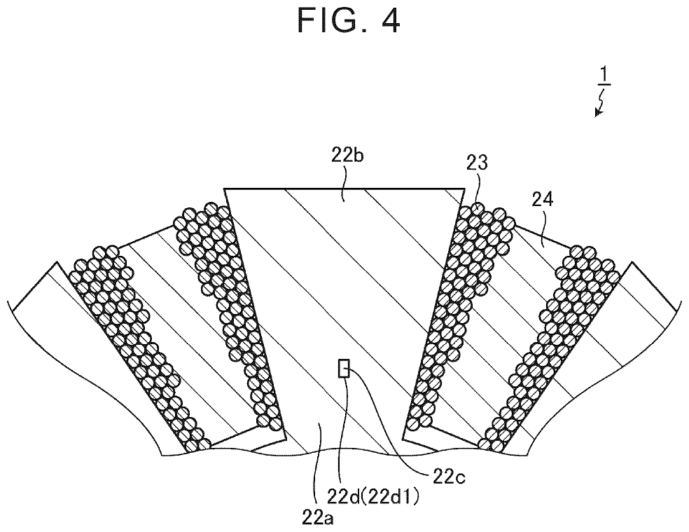

FIG. 1 is an overall plan view including a wound field motor according to an embodiment. FIG. 2 is a cross-sectional view taken along A-A line of FIG. 1. FIG. 3 is a schematic configuration diagram of a rotor included in the wound field motor according to the embodiment. FIG. 4 is an enlarged partial view of the area D1 of FIG. 3. In FIG. 1 to FIG. 4, the axial direction in the shaft direction is defined as the X direction, the circumferential direction orthogonal to the shaft direction is defined as the Y direction, and the depth direction orthogonal to the shaft direction is defined as the Z direction.

The wound field motor 1 shown in FIGS. 1 to 4 includes a substantially cylindrical stator 10 fixed to a frame (not shown) or the like, and a rotor 20 rotatably held on the inner peripheral side of the stator 10. Further, the wound field motor 1 includes a stator cooling pipe 30 for cooling the stator 10, an ATF temperature sensor 40 (see FIG. 2) for detecting the temperature of the cooling oil, and a stator coil temperature sensor 50 (see FIG. 2) for detecting the temperature of the stator 10.

The stator 10 includes a stator core 11 and a stator coil 12 wound around the stator core 11. The stator coil 12 is wound around a plurality of teeth (not shown) provided radially inward of the stator core 11.

The rotor 20 includes a shaft 21, a rotor core 22 fixed to the shaft 21, a rotor coil 23 wound around the rotor core 22, and a hard portion 24.

The shaft 21 has a hollow-portion 21a. Further, the shaft 21 has a shaft-side cooling hole 21b, 21c extending from the hollow portion 21a toward the outer peripheral surface of the shaft 21 on each of the axial upper end side and the lower end side in the hollow portion 21a.

The rotor core 22 includes a cylindrical back yoke 22a, a plurality of teeth 22b (eight in FIG. 1) extending radially outward from an outer peripheral surface of the back yoke 22a, and a slot (not shown) formed by the back yoke 22a and the teeth 22b.

Further, the rotor core 22 includes a plurality of cooling holes 22c provided in each of the plurality of teeth 22b and extending along the axial direction. A refrigerant such as cooling oil from one of the shaft-side cooling hole 21b and the shaft-side cooling hole 21c flows into each of the plurality of cooling holes 22c via a gap. The gap is a gap (not shown) between the rotor coil 23 and the rotor core 22, which will be described later, and is a gap in which insulating paper (not shown) is interposed. Each of the plurality of cooling holes 22c is provided on the upper end side or the lower end side of each of the plurality of teeth 22b alternately along the circumferential direction, and has an injection port 22d for injecting (discharging) the refrigerant. In the following description, the side from which the refrigerant is ejected from the upper end side of the tooth 22b is referred to as a refrigerant injection port 22d1, and the side from which the refrigerant is ejected from the upper end side of the tooth 22b is referred to as a refrigerant injection port 22d2.

The rotor coil 23 is formed and accommodated in a slot by winding a coil element wire in a tooth 22b.

The hard part 24 is filled between the rotor coil 23 and the slotted 23c, and is made hard while the coil end of the rotor coil 23 is exposed.

### Flow of Refrigerant

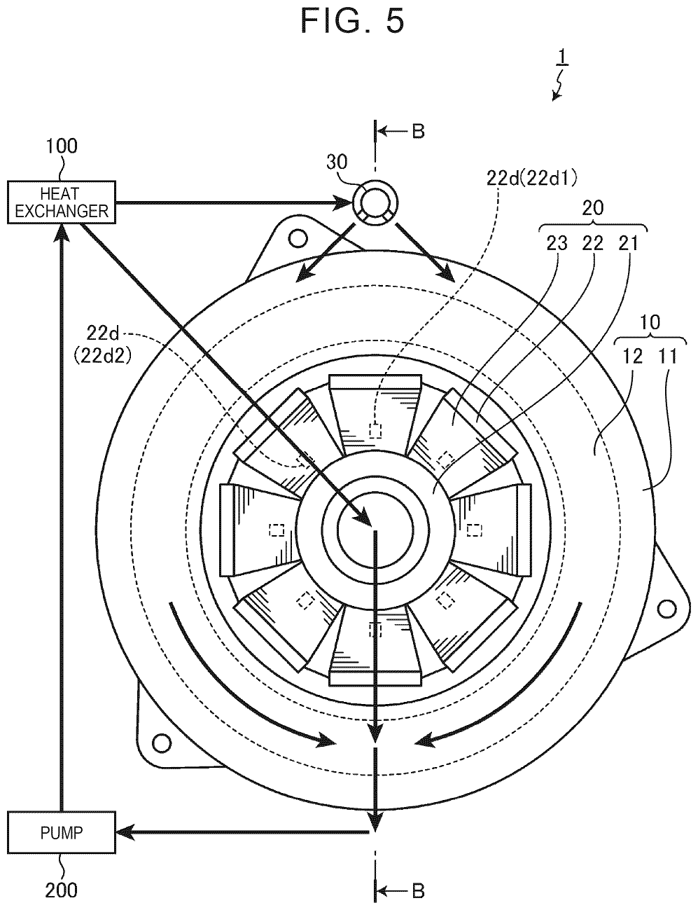

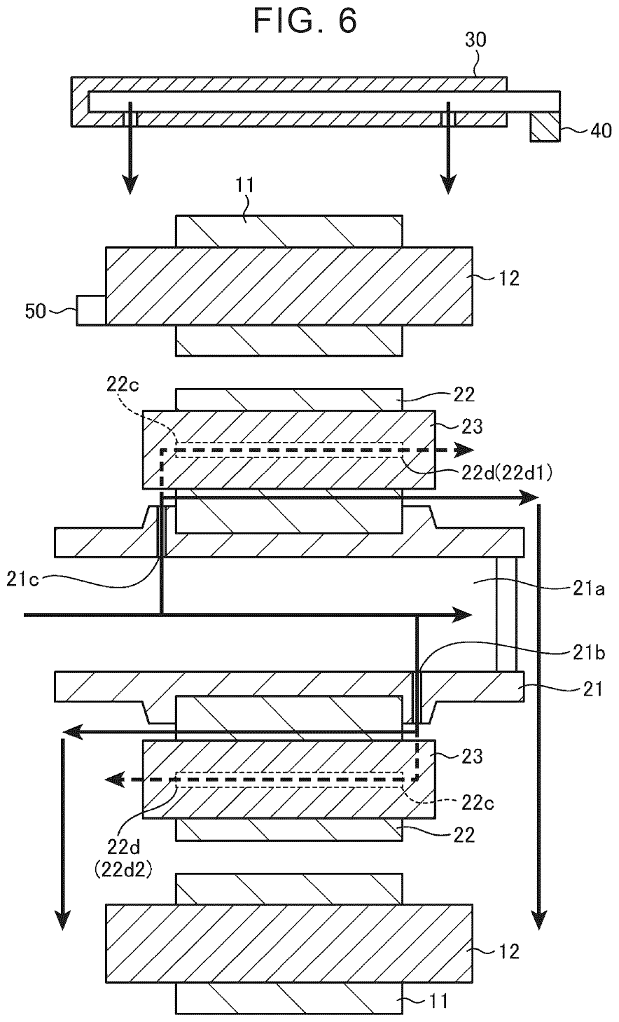

The flow of the refrigerant to the wound field motor 1 configured as described above will be described. FIG. 5 is an overall plan view illustrating a flow path of the refrigerant in the wound field motor 1. FIG. 6 is a cross-sectional view taken along B-B line of FIG. 5. In FIGS. 5 and 6, arrows schematically show the flow of the refrigerant.

As shown in FIGS. 5 and 6, the wound field motor 1 is connected to the heat exchanger 100 and the pump 200 via a flow path such as a pipe (not shown), and is cooled by the refrigerant supplied from the pump 200.

The pump 200 supplies the coolant to the stator cooling-pipe 30 and the hollow-portion 21a of the shaft 21 via a flow path (not shown). In this case, the refrigerant injected (discharged) from the stator cooling pipe 30 cools the surfaces of the stator 10 and the rotor 20 and circulates to the pump 200.

Further, the refrigerant supplied to the hollow portion 21a of the shaft 21 moves from the hollow portion 21a of the shaft 21 to each of the plurality of cooling holes 22c provided in the tooth 22b of the rotor core 22. Then, the refrigerant in each of the plurality of cooling holes 22c is injected (discharged) from the refrigerant injection port 22d1 or the refrigerant injection port 22d2 in the tooth 22b of the rotor core 22, and circulates to the pump 200.

According to the embodiment described above, the wound field motor 1 can directly cool the tooth 22b with the coolant. As a consequence, in the present embodiment, the tooth cooling having a larger surface area in contact with the rotor coil 23 than the cooling of the conventional slotted 23c is obtained, and the cooling can be performed including the inside of the rotor coil 23 wound around the tooth cooling.

Further, according to one embodiment, the wound field motor 1 has a refrigerant injection port 22d1 provided on the upper end side of the tooth 22b of the rotor core 22 and a refrigerant injection port 22d2 provided on the lower end side. With this configuration, in the present embodiment, the temperature of the refrigerant is not increased at the time when the refrigerant reaches the opposite side (from the lower end side to the upper end side) of the rotor core 22 as in the conventional injection (discharge) of the refrigerant only from one side. As a result, in the present embodiment, sufficient cooling can be expected as compared with the conventional injection (discharge) of the refrigerant from only one side, so that the rotor 20 can be cooled uniformly.

Additional benefits and variations can be readily derived by one of ordinary skill in the art. The broader aspects of the disclosure are not limited to the specific details and representative embodiments presented and described above. Accordingly, various modifications may be made without departing from the spirit or scope of the general inventive concept as defined by the appended claims and their equivalents.

While some of the embodiments of the present application have been described in detail with reference to the drawings, these are merely examples, and the present disclosure can be implemented in other forms in which various modifications and improvements are made based on the knowledge of a person skilled in the art, including the aspects described in the section of the disclosure of the present disclosure.

What is claimed is:

1. A wound field motor comprising:
a shaft having a hollow portion;
a rotor core fixed to the shaft; and
a rotor coil wound around the rotor core, wherein the rotor core includes:
a cylindrical back yoke;
a plurality of teeth that extends radially outward from an outer peripheral surface of the back yoke and around which the rotor coil is wound; and
cooling holes provided in the teeth and extending along an axial direction.

2. The wound field motor according to claim 1, wherein the cooling holes include ejection ports that are provided along a circumferential direction alternately on an upper end side or a lower end side of the teeth, and configured to eject refrigerant.
